(19) United States
(12) Patent Application Publication
(10) Pub. No.: US 2024/0150098 A1
(43) Pub. Date: May 9, 2024

(54) LAMINATE AND PACKAGE

(71) Applicants: TOYO INK SC HOLDINGS CO., LTD., Tokyo (JP); TOYO-MORTON, LTD., Tokyo (JP)

(72) Inventors: Hiroki NODA, Tokyo (JP); Hiroaki TAKAI, Tokyo (JP); Michihisa KOFUJI, Tokyo (JP)

(73) Assignees: TOYO INK SC HOLDINGS CO., LTD., Tokyo (JP); TOYO-MORTON, LTD., Tokyo (JP)

(21) Appl. No.: 18/502,063

(22) Filed: Nov. 5, 2023

(30) Foreign Application Priority Data
Nov. 7, 2022 (JP) 2022-177760

(51) Int. Cl. B65D 65/42; B65D 65/40

(52) U.S. Cl. CPC B65D 65/42; B65D 65/40

(57) ABSTRACT

The disclosure provides a laminate having excellent flexibility and substrate conformability and favorable adhesive strength in a structure having an adhesive layer using a solvent-free adhesive in contact with an ink layer using a water-based flexo ink. The disclosure provides a package using the laminate and having excellent substrate conformability and adhesive strength.

The above object is achieved by a laminate having a first substrate layer, an ink layer, an adhesive layer, and a second substrate layer in order, and satisfying the following (1) to (2):
(1) the ink layer is a layer formed using a water-based flexo ink (F).
(2) the adhesive layer is a layer formed using a solvent-free adhesive (S) containing a polyol (A) and a polyisocyanate (B), and has a storage elastic modulus (Er) of 600 MPa or less at 20° C. measured based on JIS K 7244.

### CROSS-REFERENCE TO RELATED APPLICATION

This application claims the priority benefit of Japan application no. 2022-177760, filed on Nov. 7, 2022. The entirety of the above-mentioned patent application is hereby incorporated by reference herein and made a part of this specification.

### BACKGROUND

### Technical Field

The disclosure relates to a laminate that can be applied to a packaging material for foodstuffs, medical products, cosmetics and the like and a package using the laminate. In addition, the disclosure relates to a laminate having an ink layer formed of a water-based flexo ink and an adhesive layer formed of a solvent-free adhesive, and having excellent substrate conformability and adhesive strength and excellent quality stability and a package using the laminate.

### Description of Related Art

Conventionally, a laminate in which at least an ink layer and an adhesive layer are arranged between two substrates is suitably used as a packaging material used for packaging foodstuffs, medical products, cosmetics and the like. Thus, in order to reduce the burden on the environment, formation of the ink layer and the adhesive layer using a water-based ink that does not contain an organic solvent or has a very small content of an organic solvent and a reactive solvent-free adhesive formed of a polyol and a polyisocyanate has been examined.

Generally, the reactive solvent-free adhesive lowers the viscosity due to the molecular weights of the polyol and polyisocyanate which are contained being made lower, and secures coatability. Therefore, a cured product obtained by curing a solvent-free adhesive has a lower molecular weight than a cured product of a solvent-based adhesive, and tends to have poor physical properties due to lack of a cohesive force.

In the above circumstance, for example, Patent Document 1 discloses a laminate having an ink layer formed of a water-based ink and an adhesive layer formed of a solvent-free adhesive that requires a partially terminally acid-modified polyol component in order, and having a favorable appearance.

In addition, for example, Patent Document 2 discloses a laminate having an ink layer formed of a water-based ink and an adhesive layer formed of a solvent-free adhesive in order and having excellent gas barrier properties.

### PATENT DOCUMENTS

[Patent Document 1] Japanese Patent Laid-Open No. 2021-066031
[Patent Document 2] Japanese Patent Laid-Open No. 2020-168837

### SUMMARY

On the other hand, since the laminate used as a packaging material is bent during a bag making procedure, a filling procedure, a distribution procedure and the like, and subjected to long-term distortion, the adhesive layer is required to have substrate conformability so that it does not peel off of the substrate even when it is bent.

However, as described above, since the molecular weight of the solvent-free adhesive is set low, the molecular weight of the isocyanate component to be contained is also often set low. Therefore, when applied onto the ink layer, low-molecular-weight components such as isocyanate monomers in the adhesive easily penetrate into the ink layer and react with components in the ink layer. Particularly, water and other hydroxyl group-containing components are more likely to remain in a water-based ink layer formed using a water-based ink than a solvent ink layer formed using a solvent ink. Therefore, when the solvent-free adhesive is applied onto the water-based ink layer, the low-molecular-weight polyisocyanate component in the adhesive layer reacts with residual water and the hydroxyl group-containing component in the ink layer and produces a urea bond. Since the urea bond produced in this manner has higher binding energy than the urethane bond, the degree of freedom of the polymer in the adhesive layer decreases and the adhesive layer becomes rigid.

That is, in the laminate in which the water-based ink layer and the solvent-free adhesive layer are in contact with each other, there are problems that, due to the above reasons, the adhesive layer tends to become rigid and the substrate conformability tends to deteriorate. In particular, the water-based flexo ink has problems that the porosity in the ink layer tends to increase due to a high pigment concentration, and accordingly, the amount of residual water in the ink layer increases, and substrate conformability is more likely to deteriorate.

However, Patent Document 1 and Patent Document 2 disclose a solvent-free adhesive for forming an adhesive layer containing a polyester-based polyol component, but there are problems that, since only the polyester-based polyol component is used as the polyol component, the adhesive after curing becomes a rigid cured product, the flexibility is insufficient, and substrate conformability is poor.

Therefore, the disclosure provides a laminate having a structure including an adhesive layer using a solvent-free adhesive in contact with an ink layer using a water-based flexo ink, and having excellent flexibility and substrate conformability and favorable adhesive strength. In addition, an object of the disclosure is to provide a package using the laminate and having excellent substrate conformability and adhesive strength.

A laminate according to one aspect of the disclosure is a laminate having a first substrate layer, an ink layer, an adhesive layer, and a second substrate layer in order, and satisfying the following (1) to (2):
(1) The ink layer is a layer formed using a water-based flexo ink (F).
(2) The adhesive layer is a layer formed using a solvent-free adhesive (S) containing a polyol (A) and a polyisocyanate (B), and has a storage elastic modulus (Er) of 600 MPa or less at 20° C. measured based on JIS K 7244.

### DESCRIPTION OF THE EMBODIMENTS

A laminate according to one aspect of the disclosure is a laminate having a first substrate layer, an ink layer, an adhesive layer, and a second substrate layer in order, and satisfying the following (1) to (2):
(1) The ink layer is a layer formed using a water-based flexo ink (F);
(2) The adhesive layer is a layer formed using a solvent-free adhesive (S) containing a polyol (A) and a polyisocyanate (B), and has a storage elastic modulus (Er) of 600 MPa or less at 20° C. measured based on JIS K 7244.

In the laminate according to one aspect of the disclosure, the polyol (A) contains a polyester polyol (a1) and at least one polyol (a2) selected from the group consisting of a castor oil-based polyol and a polyether polyol.

In the laminate according to one aspect of the disclosure, the polyisocyanate (B) contains a polyurethane polyisocyanate which is a reaction product of a polyester polyol (b1) having a number-average molecular weight of 1,000 to 3,000 and a polyisocyanate (b2).

In the laminate according to one aspect of the disclosure, the ink layer has a storage elastic modulus (Er) of 1,000 MPa or less at 20° C. measured based on JIS K 7244.

In the laminate according to one aspect of the disclosure, the adhesive layer has a loss tangent (tan δ) of 0.2 to 0.8 at 20° C. measured based on JIS K 7244.

In the laminate according to one aspect of the disclosure, the ink layer has a loss tangent (tan δ) of 0.20 to 0.80 at 20° C. measured based on JIS K 7244.

A package according to one aspect of the disclosure is obtained using the laminate.

According to the disclosure, it is possible to provide a laminate having a structure including an adhesive layer using a solvent-free adhesive in contact with an ink layer using a water-based flexo ink, and having excellent flexibility and substrate conformability and favorable adhesive strength. In addition, according to the disclosure, it is possible to provide a package using the laminate and having excellent substrate conformability and adhesive strength.

The disclosure relates to a laminate having a first substrate layer, an ink layer, an adhesive layer, and a second substrate layer in order and satisfying the following (1) to (2):
(1) The ink layer is a layer formed using a water-based flexo ink (F).
(2) The adhesive layer is a layer formed using a solvent-free adhesive (S) containing a polyol (A) and a polyisocyanate (B), and has a storage elastic modulus (Er) of 600 MPa or less at 20° C. measured based on JIS K 7244.

When the storage elastic modulus of the adhesive layer conforms to the above numerical values, in a structure in which the water-based ink layer and the adhesive layer are in contact with each other, the adhesive layer has excellent flexibility, and prevents delamination even if the laminate is left bent for a long time. Accordingly, it is possible to maintain quality even when used in a form that is subjected to much distortion such as in a processing process and a distribution process.

In addition, when the loss tangent is in a predetermined range, the balance between flexibility (viscosity) and elasticity becomes better, which is excellent for achieving both the stress relaxation ability due to elongation of the adhesive layer and the cohesive force for adhering substrates together.

<<Adhesive Layer>>

The adhesive layer in the disclosure is a layer (cured product) formed using a solvent-free adhesive (S) containing a polyol (A) and a polyisocyanate (B), and it is important for the solvent-free adhesive (S) in the present embodiment to have a storage elastic modulus (Er) of 600 MPa or less at 20° C. measured based on JIS K 7244 after the laminate having a first substrate layer, an ink layer, an adhesive layer, and a second substrate layer in order is cured.

<Storage Elastic Modulus (Er)>

When the storage elastic modulus (Er) is 600 MPa or less, even if the ink layer formed of a water-based flexo ink (F) and the adhesive layer are adjacent to each other, the adhesive layer exhibits flexibility and exhibits excellent substrate conformability.

In order to improve heat resistance, the storage elastic modulus is preferably 5 MPa or more, and more preferably 10 MPa or more. In addition, in order to improve flexibility, the storage elastic modulus is preferably 500 MPa or less, and more preferably 450 MPa or less.

The storage elastic modulus can be determined, for example, by the following method based on JIS K 7244.

The solvent-free adhesive (S) is mixed and made homogenous using a commercially available rotation and revolution type vacuum defoaming machine (“ARV-310P” commercially available from Thinky Corporation) and is then spread thinly on a non-corona-treated CPP film using an applicator so that the thickness is 10 to 100 μm, is sandwiched by the same film being used above, and left in an environment of 40° C. and 65% RH for 10 days, and the adhesive is cured to produce a laminate. Subsequently, the laminate is cut into a length of 20 mm and a width of 5 mm, and the CPP film is peeled off to obtain a cured film with a length of 20 mm, a width of 5 mm, and a thickness of 100 μm. For the obtained cured film, using a dynamic viscoelasticity measuring device (“DVA-200” commercially available from IT Measurement Control Co., Ltd.), the storage elastic modulus of the test piece is measured at a measurement temperature of 20° C., a frequency of 10 Hz, and a heating rate of 10° C./min, and the value of the storage elastic modulus at 20° C. is calculated.

<Loss Tangent (Tan δ)>

The solvent-free adhesive (S) in the present embodiment preferably has a loss tangent (tan δ) of 0.2 to 0.8 at 20° C. measured based on JIS K 7244 after the laminate having a first substrate layer, an ink layer, an adhesive layer, and a second substrate layer in order is cured. If the loss tangent is 0.2 or more, this is preferable because the flexibility (viscosity) is improved and substrate conformability is improved. If the loss tangent is 0.8 or less, this is preferable because the cohesive force (elasticity) that attracts the adjacent substrate and ink layer increases and the adhesive strength is improved. The loss tangent is more preferably 0.2 to 0.5.

The loss tangent can be determined by, for example, the following method.

The solvent-free adhesive (S) is mixed and made homogenous using a commercially available rotation and revolution type vacuum defoaming machine (“ARV-310P” commercially available from Thinky Corporation) and is then spread thinly on a non-corona-treated CPP film using an applicator so that the thickness is 10 to 100 μm, is sandwiched by the same film being used above, and left in an environment of 40° C. and 65% RH for 10 days, and the adhesive is cured to produce a laminate. Subsequently, the laminate is cut into a length of 20 mm and a width of 5 mm, and the CPP film is peeled off to obtain a cured film with a length of 20 mm, a width of 5 mm, and a thickness of 100 μm. For the obtained cured film, using a dynamic viscoelasticity measuring device (“DVA-200” commercially available from IT Measurement Control Co., Ltd.), the loss tangent of the test piece is measured at a measurement temperature of 20° C., a frequency of 10 Hz, and a heating rate of 10° C./min, and the value of the loss tangent at 20° C. is calculated.

<Polyol (A)>

The polyol (A) may be any compound having two or more hydroxyl groups, and can be selected from among known polyols. Examples of polyols include polyester polyol, polycarbonate polyol, polycaprolactone polyol, polyether polyol, polyolefin polyol, acrylic polyol, silicone polyol, castor oil-based polyol, and fluorine polyol.

In addition, the polyol (A) may be a polyurethane polyol that is a reaction product of a polyol and a polyisocyanate. Inclusion of a polyurethane polyol having a urethane bond is preferable because the cohesive force of the adhesive layer is improved and the adhesive strength is improved. As the polyisocyanate, compounds described in the section <Polyisocyanate (B)> to be described below can be used.

The polyol (A) may be one in which a carboxy group is introduced by reacting some of hydroxyl groups with an acid anhydride. Examples of acid anhydrides include pyromellitic anhydride, mellitic anhydride, trimellitic anhydride, and trimellitic acid ester anhydride. Examples of trimellitic acid ester anhydrides include ester compounds obtained by an esterification reaction of an alkylene glycol or alkanetriol having 2 to 30 carbon atoms and trimellitic anhydride, and ethylene glycol bis(anhydrotrimellitate), propylene glycol bis(anhydrotrimellitate) and the like can be used.

These polyols (A) may be used alone or two or more thereof may be used in combination.

In consideration of the adhesive strength and substrate conformability, the polyol (A) preferably contains a polyester polyol (a1) and at least one polyol (a2) selected from the group consisting of a castor oil-based polyol and a polyether polyol. When the polyol (A) contains a polyester polyol (a1), the cohesive force of the adhesive layer increases and the adhesive strength is improved. In addition, when a polyol (a2), which is one selected from among a castor oil-based polyol and a polyether polyol, is included, a decrease in flexibility due to improved cohesive force of the adhesive layer is minimized, and the substrate conformability of the adhesive layer is improved.

Examples of polyester polyols (a1) include a reaction product of polybasic acids and polyhydric alcohols. The polybasic acids preferably contain 90 mass % or more and more preferably 100 mass % of aliphatic polybasic acids, and the polyhydric alcohols contain preferably 90 mass % or more, and more preferably 100 mass % of aliphatic polyhydric alcohols.

In this specification, a polyester polyol that is a reaction product of polybasic acids containing 90 mass % or more of aliphatic polybasic acids and polyhydric alcohols containing 90 mass % or more of aliphatic polyhydric alcohols is called an aliphatic polyester polyol. If the polyester polyol contains an aliphatic polyester polyol, this is preferable because the flexibility of the adhesive layer is improved and the substrate conformability is improved.

Examples of castor oil-based polyols include castor oil, a castor oil urethane polyol obtained by urethanizing castor oil, a castor oil ester polyol obtained by esterizing castor oil, a dehydrated castor oil, a castor hardened oil which is a hydrogen additive of castor oil, a castor oil fatty acid, a dehydrated castor oil fatty acid, a castor oil fatty acid condensate, and an adduct obtained by adding 5 to 50 mol of ethylene oxide to castor oil. Among these, castor oil is preferable in consideration of imparting flexibility.

For castor oil-based polyols, commercial products may be used. Examples of commercial products include Industrial Grade 1 castor oil (commercially available from Hokoku Corporation), CO-FA (castor oil fatty acid, commercially available from Hokoku Corporation), HS 2G-120 (castor oil-based polyol, commercially available from Hokoku Corporation), HS 2G-160R (castor oil-based polyol, commercially available from Hokoku Corporation), and HS 2G-270B (castor oil-based polyol, commercially available from Hokoku Corporation).

The polyether polyol may be any compound having two or more hydroxyl groups and two or more ether bonds in the molecule, and may be either a bifunctional polyether polyol or a tri- or higher functional polyether polyol. In consideration of imparting flexibility, the polyether polyol is preferably a bifunctional polyether polyol.

<Polyisocyanate (B)>

Examples of polyisocyanates (B) include a polyurethane polyisocyanate obtained by reacting a polyol (b1) and a polyisocyanate (b2) under conditions in which the amount of isocyanate groups is in excess. If such a polyisocyanate having a urethane bond is included, this is preferable because the cohesive force of the adhesive layer increases and the adhesive strength is improved.

[Polyol]

As the polyol, those described in the above section <Polyol (A)> can be used, but in order to increase the cohesive force of the adhesive layer and improve the adhesive strength, a polyester polyol is preferably included. In consideration of the cohesive force, the molecular weight of the polyester polyol is preferably 1,000 or more. In addition, in consideration of substrate conformability, the molecular weight is preferably 3,000 or less.

That is, the polyisocyanate (B) preferably contains a polyurethane polyisocyanate which is a reaction product of a polyester polyol (b1) having a number-average molecular weight of 1,000 to 3,000 and a polyisocyanate (b2).

When the polyurethane polyisocyanate is obtained, the ratio of the number of isocyanate groups in the polyisocyanate (b2) to the number of hydroxyl groups in the polyol (b1) (number of NCO moles/number of OH moles) is preferably 3 to 5. If the ratio is 3 or more, this is preferable because the concentration of urethane bonds in the adhesive layer increases and the adhesive strength is improved. If the ratio is 5 or less, this is preferable because the amount of residual isocyanate monomers is reduced, the flexibility of the adhesive layer is improved, and the substrate conformability is improved.

Examples of polyester polyols include a reaction product of polybasic acids and polyhydric alcohols. The polybasic acids contain preferably 90 mass % or more and more preferably 100 mass % of aliphatic polybasic acids, and the polyhydric alcohols contain preferably 90 mass % or more, and more preferably 100 mass % of aliphatic polyhydric alcohols.

In this specification, a polyester polyol that is a reaction product of polybasic acids containing 90 mass % or more of aliphatic polybasic acids and polyhydric alcohols containing 90 mass % or more of aliphatic polyhydric alcohols is called an aliphatic polyester polyol. If the polyester polyol contains an aliphatic polyester polyol, this is preferable because the flexibility of the adhesive layer is improved and the substrate conformability is improved.

[Polyisocyanate]

Examples of polyisocyanates include aromatic polyisocyanates, aromatic aliphatic polyisocyanates, aliphatic polyisocyanates, alicyclic polyisocyanates, and modified products thereof. These polyisocyanates may be used alone or two or more thereof may be used in combination.

(Aromatic Polyisocyanate)

Examples of aromatic polyisocyanates include aromatic diisocyanates such as diphenylmethane diisocyanate, carbodiimide-modified diphenylmethane diisocyanate, phenylene diisocyanate, tolylene diisocyanate, and naphthalene diisocyanate; and aromatic polyisocyanates such as polymeric diphenylmethane diisocyanates.

(Aromatic Aliphatic Polyisocyanate)

As aromatic aliphatic polyisocyanates, for example, aromatic aliphatic diisocyanates such as 1,3- or 1,4-xylylene diisocyanate or a mixture thereof, and ω,ω′-diisocyanate-1,4-diethylbenzene, 1,3- or 1,4-bis(1-isocyanate-1-methylethyl)benzene or a mixture thereof may be exemplified.

(Aliphatic Polyisocyanate)

Examples of aliphatic polyisocyanates include aliphatic diisocyanates such as trimethylene diisocyanate, tetramethylene diisocyanate, hexamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, 2,6-diisocyanate methyl caproate, lysine diisocyanate, and dimer acid diisocyanate.

(Alicyclic Polyisocyanate)

Examples of alicyclic polyisocyanates include alicyclic diisocyanates such as 1,4-cyclohexane diisocyanate, 1,3-cyclohexane diisocyanate, isophorone diisocyanate, 4,4′-methylenebis(cyclohexyl isocyanate), methyl 2,4-cyclohexane diisocyanate, methyl 2,6-cyclohexane diisocyanate, 1,4-bis(isocyanate methyl)cyclohexane, 1,3-bis(isocyanate methyl)cyclohexane, and norbornene diisocyanate.

Examples of modified polyisocyanate products include allophanate type modified products, isocyanurate type modified products, biuret type modified products, and adduct type modified products. In addition, as the modified polyisocyanate product, a polyisocyanate having a urethane bond, which is a reaction product of a polyisocyanate and a polyol may be used.

The polyol for forming the modified polyisocyanate product is not particularly limited, and examples thereof include polyester polyol, polyether polyol, polycarbonate polyol, polycaprolactone polyol, polyolefin polyol, acrylic polyol, silicone polyol, castor oil polyol, and fluorine polyol.

The polyisocyanate is preferably an aromatic polyisocyanate and more preferably a diphenylmethane diisocyanate. That is, the polyisocyanate (B) preferably has a structural unit derived from an aromatic polyisocyanate. When a structural unit derived from an aromatic polyisocyanate is contained, the cohesive force of the adhesive layer increases and the shearing stress rapidly increases. This is preferable because it improves the appearance. In addition, it is preferable because the next lamination process and packaging bag processing can be performed with a short storage time.

The polyisocyanate (B) desirably contains a polyurethane polyisocyanate which is a reaction product of a polyol and a polyisocyanate. If an isocyanate-terminated prepolymer having a urethane bond is contained, this is preferable because the cohesive force of the adhesive layer is improved and the adhesive strength is improved.

The isocyanate group content of the polyisocyanate (B) is preferably 5 mass % to 25 mass %, more preferably 8 mass % to 20 mass %, and still more preferably in a range of 12 mass % to 20 mass %. If the content is 5 mass % or more, this is preferable because the concentration of urethane bonds in the adhesive layer increase and the adhesive strength is improved. If the content is 25 mass % or less, this is preferable because the amount of residual isocyanate monomers is reduced, the flexibility of the adhesive layer is improved, and substrate conformability is improved.

In the solvent-free adhesive (S), when the polyol (A) and the polyisocyanate (B) are blended, the ratio of the number of isocyanate groups in the polyisocyanate (B) to the number of hydroxyl groups in the polyol (A) (number of NCO moles/number of OH moles) is preferably 1.0 to 3.0, and more preferably 1.2 to 2.2. If the ratio is within the above range, this is preferable because the crosslinking density is well-balanced and it is possible to achieve both the adhesive strength and the substrate conformability.

<Other Components>

The solvent-free adhesive (S) may contain components other than the above components in order to satisfy various physical properties required for the adhesive or the package. These other components may be blended with either a polyol (A) or a polyisocyanate (B), or may be added when the polyol (A) and the polyisocyanate (B) are blended. These other components may be used alone or two or more thereof may be used in combination.

(Silane Coupling Agent)

The solvent-free adhesive (S) may contain a silane coupling agent in order to improve the adhesive strength with respect to a metal material such as a metal foil. Examples of silane coupling agents include trialkoxysilanes having a vinyl group such as vinyltriethoxysilane; trialkoxysilanes having an amino group such as 3-aminopropyltriethoxy silane, and N-(2-aminoethyl)-3-aminopropyltrimethoxy silane; and trialkoxysilanes having a glycidyl group such as 3-glycidoxypropyltrimethoxysilane, 2-(3,4-epoxy cyclohexyl)-ethyltrimethoxysilane, and 3-glycidoxypropyltriethoxysilane.

The content of the silane coupling agent based on a total solid content of the adhesive is preferably 0.1 to 5 mass %, and more preferably 0.2 to 3 mass %. If the content is within the above range, this is preferable because it is possible to improve the adhesive strength with respect to a metal foil.

(Phosphoric Acid or Phosphoric Acid Derivatives)

The solvent-free adhesive (S) may contain phosphoric acid or phosphoric acid derivatives in order to improve the adhesive strength with respect to a metal material such as a metal foil.

The phosphoric acid may be any acid having at least one free oxoacid, and examples thereof include phosphoric acids such as hypophosphorous acid, phosphorous acid, orthophosphoric acid, and hypophosphoric acid; and condensed phosphoric acids such as metaphosphoric acid, pyrophosphoric acid, tripolyphosphoric acid, polyphosphoric acid, and ultraphosphoric acid. In addition, examples of phosphoric acid derivatives include those obtained by partially esterifying the above phosphoric acid with alcohols while at least one free oxoacid remains. Examples of alcohols include aliphatic alcohols such as methanol, ethanol, ethylene glycol, and glycerin; and aromatic alcohols such as phenol, xylenol, hydroquinone, catechol, and phloroglucinol.

The content of phosphoric acid or its derivatives based on a total solid content of the adhesive is preferably 0.01 to 10 mass %, more preferably 0.05 to 5 mass %, and particularly preferably 0.05 to 1 mass %.

(Leveling Agent or Antifoaming Agent)

The solvent-free adhesive (S) may further contain a leveling agent and/or an antifoaming agent in order to improve the appearance of the laminate. Examples of leveling agents include polyether-modified polydimethylsiloxane, polyester-modified polydimethylsiloxane, aralkyl-modified polymethylalkylsiloxane, polyester-modified hydroxyl group-containing polydimethylsiloxane, polyether ester-modified hydroxyl group-containing polydimethylsiloxane, acrylic copolymers, methacrylic copolymers, polyether-modified polymethylalkylsiloxane, acrylic acid alkyl ester copolymers, methacrylic acid alkyl ester copolymers, and lecithin.

Examples of antifoaming agents include silicone resins, silicone solutions, and copolymers of alkyl vinyl ethers, acrylic acid alkyl esters, and methacrylic acid alkyl esters.

(Reaction Accelerator)

The solvent-free adhesive (S) may further contain a reaction accelerator in order to accelerate the curing reaction. Examples of reaction accelerators include metal catalysts such as dibutyltin diacetate, dibutyltin dilaurate, dioctyltin dilaurate, and dibutyltin dimalate; tertiary amines such as 1,8-diaza-bicyclo(5,4,0)undecene-7, and 1,5-diazabicyclo(4,3,0)nonene-5, 6-dibutylamino-1,8-diazabicyclo(5,4,0)undecene-7; and reactive tertiary amines such as triethanolamine.

(Other Additives)

The solvent-free adhesive (S) may contain various additives as long as the effects of the disclosure are not impaired. Examples of additives include inorganic filling agents such as silica, alumina, mica, talc, aluminum flakes, and glass flakes, layered inorganic compounds, stabilizers (antioxidants, heat stabilizers, ultraviolet absorbers, hydrolysis inhibitors, etc.), rust inhibitors, thickeners, plasticizers, antistatic agents, lubricants, antiblocking agents, colorants, fillers, crystal nucleating agents, and catalysts for adjusting the curing reaction.

<Formation of Adhesive Layer>

After a known lamination processing such as roll coating, for example, the solvent-free adhesive (S) is cured by being left under conditions of 20 to 60° C. for about 24 hours to 1 week to form an adhesive layer.

In order to improve the appearance and physical properties of the laminate, the thickness of the adhesive layer is preferably 1.0 μm to 5.0 μm, and more preferably 1.5 μm to 4.5 μm. If the thickness of the adhesive layer is 1.0 μm or more, this is preferable because leveling properties after the adhesive is applied are improved, the unevenness of the print surface is filled, and the appearance performance is improved. In addition, this is preferable because, when the laminate is bent, the elongation percentage of the adhesive layer increases and the substrate conformability is improved. If the thickness of the adhesive layer is 5.0 μm or less, this is preferable because the cohesive force of the adhesive layer increases, movement of trapped fine bubbles is restricted, and the appearance performance is improved.

<<Ink Layer>>

The ink layer in the disclosure is a layer formed using a water-based flexo ink (F) and containing at least a colorant and a water-based resin.

<Colorant>

As the colorant, pigments such as an inorganic colorant and an organic colorant can be suitably used.

Examples of inorganic colorants include titanium oxide, zinc oxide, zinc sulfide, barium sulfate, calcium carbonate, aluminum hydroxide, chromium oxide, silica, carbon black, aluminum, and mica. In consideration of coloring power, hiding power, chemical resistance, and weather resistance, as a white colorant, titanium oxide is preferable, and titanium oxide whose pigment surface is basic is more preferable. Aluminum is in the form of powder or paste, and in consideration of handling and safety, a paste aluminum is preferably used, and whether to use leafing or non-leafing is appropriately selected in consideration of brightness and concentration.

Examples of organic colorants include organic pigments and dyes used in general inks, paints, recording materials and the like. Examples of such organic colorants include azo pigments, phthalocyanine pigments, anthraquinone pigments, perylene pigments, perinone pigments, quinacridone pigments, thioindigo pigments, dioxazine pigments, isoindolinone pigments, quinophthalone pigments, azomethine azo pigments, dictopyrrolopyrrole pigments, and isoindoline pigments. As the colorant, any compound listed in the Color Index can be used, and copper phthalocyanine is used for indigo ink, and C. I. Pigment Yellow 83 is preferably used for yellow ink in consideration of cost and light resistance.

<Water-Based Resin>

The water-based resin refers to a water-soluble or water-dispersible (emulsion) resin, and examples of resins include a urethane resin, an acrylic resin, a urethane acrylic resin, a styrene-acrylic resin, a styrene-maleic anhydride resin, a polyester resin, a rosin-modified maleic acid resin, a cellulose resin, and chlorinated polyolefin. The water-based resins may be used alone or two or more thereof may be used in combination.

[Water-Based Urethane Resin]

As the water-based resin, a water-based urethane resin is suitably used in consideration of laminate physical properties. The water-based urethane resin preferably has an ionic group such as a carboxy group or a sulfone group in the resin, and for example, it can be obtained by reacting a polyol having an ionic group such as a polyol, polyisocyanate, or polyhydroxy acid and then neutralizing the ionic group. The ionic group is preferably a carboxy group in consideration of water resistance.

[Polyol]

Examples of polyols that can be used to synthesize a water-based polyurethane resin include polyether polyols such as PEG (polyethylene glycol), PPG (polypropylene glycol) and PTMG (polyoxytetramethylene glycol); polyester polyols obtained by dehydration condensation of low-molecular-weight glycols such as ethylene glycol, 1,2-propanediol, 1,3-propanediol, 1,3-butanediol, 1,4-butanediol, neopentyl glycol, pentadiol, methyl pentadiol, hexadiol, octanediol, nonanediol, methyl nonanediol, diethylene glycol, triethylene glycol, and dipropylene glycol, and dibasic acids such as adipic acid, phthalic acid, isophthalic acid, terephthalic acid, maleic acid, fumaric acid, succinic acid, oxalic acid, malonic acid, glutaric acid, pimelic acid, azelaic acid, sebacic acid, and dimer acid or their anhydrides; polyols having a tertiary amino group such as N-methyldiethanolamine, N-ethyldiethanolamine, N-butyldiethanolamine, N-t-butyldiethanolamine, dihydroxyisopropylethylamine, dihydroxyisopropyl n-butylamine, dihydroxyisopropyl t-butylamine, and N,N-bis(2-hydroxypropyl)aniline; and various known polyols such as polycarbonate diols, polybutadiene glycols, glycols obtained by adding ethylene oxide or propylene oxide to bisphenol A, and dimer diols.

These polyols may be used alone or two or more thereof may be used in combination. In consideration of the resolubility of the water-based flexo ink (F), the polyol preferably contains polyether polyols and more preferably contains PEG (polyethylene glycol).

The water-based urethane resin preferably has a content of structural units derived from polyethylene glycol (a solid content mass percentage of polyethylene glycol in the water-based urethane resin, hereinafter abbreviated as PEG %) in a range of 5 to 50 mass %. If the PEG % is 5 mass % or more, the hydrophilicity of the resin increases and thus the stability of the water-based flexo ink (F) is improved. If the PEG % is 50 mass % or less, the viscosity of the resin decreases, the effective amount of the binder in the ink is achieved, and a decrease in strength of the ink film can be minimized.

In order to introduce an ionic group into the resin, it is preferable to use a polyol having an ionic group. The ionic group is preferably a carboxy group. Examples of such polyols having an ionic group include dimethylolalkanoic acids such as dimethylolacetic acid, dimethylolpropionic acid, dimethylolbutanoic acid, 2,2-dimethylolbutyric acid, and 2,2-dimethylolpentanoic acid, dihydroxysuccinic acid, dihydroxypropionic acid, and dihydroxybenzoic acid. These may be used alone or two or more thereof may be used in combination.

Each polyol used to synthesize a water-based polyurethane resin preferably has a number-average molecular weight of 3,000 or less. The number-average molecular weight is calculated from the hydroxyl value, and the hydroxyl value is a value obtained by converting the amount of hydroxyl groups in 1 g of a resin, which is calculated by esterifying or acetylating the hydroxyl groups in the resin and back titrating the remaining acid with an alkali, into mg of potassium hydroxide, and can be measured according to JIS K 0070. When a polyol having a number-average molecular weight of 3,000 or less is used, the ionic groups incorporated for water solubilization can be scattered into the water-based polyurethane resin, and the resolubility is improved. On the other hand, if the polyol has a larger number-average molecular weight, the polyurethane resin film becomes softer, the laminate strength tends to become better, and thus the number-average molecular weight is preferably 500 or more.

(Polyisocyanate)

Examples of polyisocyanates that can be used to synthesize water-based polyurethane resins include various known aromatic, aliphatic or alicyclic diisocyanates.

Examples of aromatic diisocyanates include 1,5-naphthylene diisocyanate, 4,4′-diphenylmethane diisocyanate, 4,4′-diphenyl dimethyl methane diisocyanate, 4,4′-dibenzyl isocyanate, dialkyl diphenylmethane diisocyanate, tetraalkyl diphenylmethane diisocyanate, 1,3-phenylene diisocyanate, 1,4-phenylene diisocyanate, tolylene diisocyanate, xylylene diisocyanate, and m-tetra methyl xylylene diisocyanate.

Examples of aliphatic diisocyanates include butane-1,4-diisocyanate, hexamethylene diisocyanate, isopropylene diisocyanate, methylene diisocyanate, 2,2,4-trimethylhexamethylene diisocyanate, and lysine diisocyanate.

Examples of alicyclic diisocyanates include cyclohexane-1,4-diisocyanate, isophorone diisocyanate, dicyclohexyl methane-4, 4′-diisocyanate, 1,3-bis(isocyanate methyl)cyclohexane, methyl cyclohexane diisocyanate, and norbornane diisocyanate.

[Water-Based Urethane Urea Resin]

The water-based urethane resin may be a water-based urethane urea resin in which a polyol (including a polyol having an ionic group) and a polyisocyanate are reacted to obtain a polyurethane resin, and a urea bond is then additionally introduced using a chain extender and a reaction terminator. The water-based urethane resin in the disclosure is preferably a water-based urethane urea resin because the coating film becomes tougher and coating film physical properties tend to improve according to introduction of urea bonds.

(Chain Extender)

As the chain extender, known amines can be used, and examples thereof include 2-hydroxyethylethylene diamine, 2-hydroxyethylpropylene diamine, di-2-hydroxyethylethylene diamine, di-2-hydroxyethylpropylene diamine, 2-hydroxypropylethylene diamine, di-2-hydroxypropylethylene diamine, ethylene diamine, propylene diamine, hexamethylene diamine, isophorone diamine, dicyclohexyl methane-4,4′-diamine, and dimer diamines obtained by converting carboxy groups of dimer acid into amino groups. These amines may be used alone or two or more thereof may be used in combination. The above amines are preferably amines having a hydroxyl group, which are preferable because they have favorable resolubility.

(Reaction Terminator)

Examples of reaction terminators include dialkylamines such as di-n-dibutylamine; amines having a hydroxyl group such as monoethanolamine, diethanolamine, 2-amino-2-methyl-1-propanol, tri(hydroxymethyl)aminomethane, 2-amino-2-ethyl-1,3-propanediol, N-di-2-hydroxyethylethylenediamine, N-di-2-hydroxyethylpropylene diamine, and N-di-2-hydroxypropylethylenediamine; and monoamine type amino acids such as glycine, alanine, glutamic acid, taurine, aspartic acid, aminobutyric acid, valine, aminocaproic acid, aminobenzoic acid, aminoisophthalic acid, and sulfamic acid.

(Neutralization)

In the water-based urethane resin, it is preferable to neutralize the ionic group in the urethane resin with a basic compound. Examples of basic compounds include inorganic base compounds such as sodium hydroxide, potassium hydroxide, and ammonia; and organic base compounds such as methylamine, ethylamine, propylamine, butylamine, hexylamine, octylamine, ethanolamine, propanol amine, diethanol amine, N-methyl diethanol amine, dimethyl amine, diethylamine, triethylamine, N,N-dimethyl ethanolamine, 2-dimethyl amino-2-methyl-1-propanol, 2-amino-2-methyl-1-propanol, and morpholine, and these may be used alone or two or more thereof may be used in combination. The basic compound is preferably ammonia or an organic base compound in consideration of water resistance of the printed material, residual odor and the like.

In consideration of solubility and blocking resistance, the water-based urethane resin in the disclosure preferably has an acid value of 15 to 65 mg KOH/g and a weight average molecular weight of 5,000 to 100,000.

<Other Components>

(Acetylene Glycol-Based Compound)

The water-based flexo ink (F) may further contain an acetylene glycol-based compound. When an acetylene glycol-based compound is contained, the leveling properties of the ink layer may be improved.

The acetylene glycol-based compound is a nonionic surfactant having an acetylene group in the center and a bilaterally symmetrical structure. Examples of commercial products of acetylene glycol-based compounds include OLFINE E1010, OLFINE E1020, SURFYNOL 104, SURFYNOL 420, SURFYNOL 440, SURFYNOL 465, and SURFYNOL 485 (commercially available from Nissin Chemical Co., Ltd.). When an acetylene glycol-based compound is contained, in consideration of laminate physical properties, the content of the acetylene glycol-based compound based on a solid content mass of the water-based flexo ink (F) is preferably 0.3 to 15 mass %, more preferably 0.6 to 9 mass %, and still more preferably 1.5 to 6 mass %.

(Extender Pigment)

The water-based flexo ink (F) may further contain an extender pigment. When an extender pigment is contained, the blocking resistance of the ink layer may be improved.

Examples of extender pigments include barium sulfate, calcium carbonate, magnesium carbonate, kaolin clay, and silica, and these may be used alone or two or more thereof may be used in combination. When an extender pigment is contained, in consideration of laminate physical properties, the content of the extender pigment based on a solid content mass of the water-based flexo ink (F) is preferably 1 to 45 mass %, more preferably 3 to 30 mass %, and still more preferably 10 to 20 mass %.

(Additives)

The water-based flexo ink (F) may contain, additives, as necessary. Examples of additives include an adhesion aid, a curing agent, an antifoaming agent, a wax, a silane coupling agent, a plasticizer, an infrared absorber, an ultraviolet absorber, a fragrance, and a flame retardant.

The adhesion aid is preferably a compound containing a hydrazide group, and examples thereof include adipic acid dihydrazide (ADH). When a compound containing a hydrazide group is used, it interacts with the keto group in the resin or curing agent to be described below, and improves adhesion to the plastic film and the strength of the ink film.

Examples of curing agents include resin fine particle dispersions containing a reactive group such as a carbodiimide group and a keto group. Examples of commercial products of such resin fine particle dispersions include Carbodilite E-02, SV-02, V-02, V-02-L2, and V-04 (commercially available from Nisshinbo Chemical Inc.), ACRONAL YJ2716D, YJ2720D, YJ2727DN, YJ2741D, and YJ2746DS (commercially available from BASF), and NEOCRYLA-1127, A-1125, A-1120, and A-1131 (commercially available from DSM NeoResins, Inc.).

When the curing agent is used, it is possible to further improve adhesion to the substrate and the strength of the ink film. The content of the curing agent based on a solid content of the water-based flexo ink (F) is preferably 1 to 45 mass %, and more preferably 5 to 20 mass %.

The water-based flexo ink (F) contains water as a medium, and preferably further contains alcohols. Examples of alcohols include methanol, ethanol, 1-propanol, 2-propanol, 1-butanol, 2-butanol, and iso-butanol. When applied to foodstuff packaging materials, in consideration of safety and hygienic properties and residual odor, it is preferable to use ethanol, 1-propanol or 2-propanol as alcohols.

In addition, for drying and adjustment, ethylene glycol, diethylene glycol, propylene glycol, dipropylene glycol and mono- or diethers thereof may be used as necessary.

In addition, the ink layer may contain resins other than the water-based urethane resin as long as the effects of the disclosure are not impaired. Examples of such other resins include water-based resins such as a polyester resin, an acrylic resin, a styrene-acrylic resin, a styrene-maleic anhydride resin, a rosin-modified maleic acid resin, a cellulose resin, and chlorinated polyolefin, and two or more thereof may be used in combination.

<Production of Water-Based Flexo Ink (F)>

A method of producing a water-based flexo ink (F) is not particularly limited, and the water-based flexo ink (F) can be produced by dispersing and mixing the above raw material using a known dispersing machine, for example, a roller mill, a ball mill, a pebble mill, an attritor, or a sand mill. If bubbles, unexpected coarse particles and the like are contained in the water-based flexo ink (F), it is preferable to remove them by filtration or the like because they reduce the quality of the printed material. A conventionally known filter machine can be used.

(Minimum Autocorrelation Length Sal on Surface of Ink Layer)

In the water-based flexo ink (F) in the disclosure, the minimum autocorrelation length (Sal) of the surface of the ink layer formed using the water-based flexo ink (F) is preferably 10 μm or less.

The minimum autocorrelation length Sal on the surface of the ink layer is a value defined according to ISO 25178, and is an evaluation index expressing the fineness of features. Specifically, it is a numerical value of the density of unevenness on the surface of the ink layer in units of length, and it can be said that the smaller the value of the minimum autocorrelation length Sal, the finer the features.

Sal can be measured using, for example, a white light interference type surface texture measuring device (TalySurf CCI MP-HS commercially available from AMETEK).

The minimum autocorrelation length Sal on the surface of the ink layer is more preferably 1 to 10 μm, still more preferably 2 to 8 μm, and particularly preferably 4 to 7 μm. If Sal is 1 μm or more, the surface area of the surface of the ink layer becomes small, and penetration of the isocyanate component in the solvent-free adhesive (S) into the ink layer and penetration of the low-molecular-weight hydroxyl group-containing component in the ink layer into the adhesive layer are prevented. Accordingly, favorable physical properties such as residual tack minimization, adhesive strength, and heat seal strength are obtained. If Sal is 10 μm or less, features on the surface of the ink layer become fine, and when the solvent-free adhesive (S) is applied, bubbles are less likely to be trapped between the ink layer and the adhesive layer, and thus the appearance after lamination is improved.

<Formation of Ink Layer>

The ink layer can be formed by printing the water-based flexo ink (F) on a substrate to be described below. As the printing method, known flexographic printing methods and gravure printing methods are suitably used, and it is obtained by performing application using the printing method, drying using an oven or the like, and fixing. The drying temperature is generally about 40 to 100° C. The thickness of the ink layer is preferably 0.1 to 5 μm, and more preferably 0.1 to 2 μm.

As the printing method, flexographic printing is more suitably used. As anilox used for flexographic printing, a cell-engraved ceramic anilox roll, a chrome-plated anilox roll or the like can be used. In order to obtain a printed material having excellent dot reproducibility, it is preferable to use an anilox roll having a number of lines that is at least 5 times and preferably 6 times a number of printing lines used during printing. For example, if the number of printing lines used is 75 lpi, an anilox of 375 lpi or more is preferable. In consideration of drying properties and blocking properties of the water-based flexo ink (F), the anilox capacity is preferably 1 to 8 cc/m², and more preferably 2 to 6 cc/m².

Examples of plates used for flexographic printing include photosensitive resin plates that use UV curing using a UV light source and elastomer material plates that use a direct laser engraving method. Regardless of the method of forming an image area of the flexoplate, a plate having a number of screening lines of 75 lpi or more is preferable. Any sleeve or cushion tape for pasting the plate can be used.

Examples of flexo printing machines include a CI-type multicolor flexo printing machine and a unit-type multicolor flexo printing machine. Examples of ink supply methods include a chamber method and a 2-roll method, and an appropriate printing machine can be used.

[Storage Elastic Modulus (Er)]

The water-based flexo ink (F) in the present embodiment preferably has a storage elastic modulus (Er) of 1,000 MPa or less at 20° C. measured based on JIS K 7244 after the laminate having a first substrate layer, an ink layer, an adhesive layer, and a second substrate layer in order is cured. If the storage elastic modulus (Er) is 1,000 MPa or less, this is preferable because the flexibility of the laminate is improved, and the substrate conformability is improved.

In order to improve heat resistance, the storage elastic modulus is preferably 50 MPa or more, and more preferably 100 MPa or more. In addition, in order to improve flexibility, the storage elastic modulus is more preferably 800 MPa or less.

The storage elastic modulus of the ink layer can be determined by, for example, the following method.

The water-based flexo ink (F) is poured into a silicone container so that the thickness after drying is 10 to 1,000 μm, and the solvent is evaporated. Then, the ink layer is cut into a width 5 mm×a length of 20 mm to produce a test piece. Using a dynamic viscoelasticity measuring device (“DVA-200” commercially available from IT Measurement Control Co., Ltd.), the storage elastic modulus of the test piece is measured at a measurement temperature of 20° C., a frequency of 10 Hz, and a heating rate of 10° C./min, and the value of the storage elastic modulus at 20° C. is calculated.

[Loss Tangent (Tan δ)]

The water-based flexo ink (F) in the present embodiment preferably has a loss tangent (tan δ) of 0.2 to 0.8 at 20° C. measured based on JIS K 7244 after the laminate having a first substrate layer, an ink layer, an adhesive layer, and a second substrate layer in order is cured. If the loss tangent is 0.2 or more, this is preferable because the flexibility (viscosity) is improved and the substrate conformability is improved. If the loss tangent is 0.8 or less, this is preferable because the cohesive force (elasticity) that attracts the adjacent substrate and adhesive layer increases and the adhesive strength is improved. The loss tangent is more preferably 0.2 to 0.5.

The loss tangent of the ink layer can be determined by, for example, the following method.

The water-based flexo ink (F) is poured into a silicone container so that the thickness after drying is 10 to 1,000 μm, and the solvent is evaporated. Then, the ink layer is cut into a width 5 mm×a length of 20 mm to produce a test piece. Using a dynamic viscoelasticity measuring device (“DVA-200” commercially available from IT Measurement Control Co., Ltd.), the loss tangent of the test piece is measured at a measurement temperature of 20° C., a frequency of 10 Hz, and a heating rate of 10° C./min, and the value of the loss tangent at 20° C. is calculated.

<Production of Laminate>

A laminate of the disclosure has a first substrate layer, an ink layer, an adhesive layer, and a second substrate layer in order, and is preferably produced by the production method including the following processes (1) and (2).
process (1): a process of flexographic printing a water-based flexo ink (F) on a first substrate to form an ink layer.
process (2): a process of applying a solvent-free adhesive (S) onto the ink layer to form an adhesive layer.

[Substrate]

The first and second substrates are not particularly limited, and examples thereof include conventionally known plastic films, paper, and metal foils, and the two substrates may be of the same type or of different types.

As the plastic film, a thermoplastic resin or thermosetting resin film can be used, and a thermoplastic resin film is preferable. Examples of thermoplastic resins include polyolefin, polyester, polyamide, polystyrene, vinyl chloride resins, vinyl acetate resins, ABS resins, acrylic resins, acetal resins, polycarbonate resins, and cellulose plastics.

The first and second substrates may have a barrier layer composed of a vapor deposited layer of a metal or metal oxide, and examples of barrier layers include a vapor deposited layer of aluminum, silica, alumina or the like.

The first substrate is preferably a plastic film. Examples of plastic films include those generally used for packaging materials, and include polyester resin films such as polyethylene terephthalate (PET), polyethylene naphthalate (PEN), and polylactic acid (PLA); polyolefin resin films such as polyethylene (PE) and polypropylene (PP); polystyrene resin films; polyamide resin films such as nylon 6, and poly-p-xylylene adipamide (MXD 6 nylon); polycarbonate resin films; polyacrylonitrile resin films; polyimide resin films; and their composites (for example, nylon 6/MXD 6/nylon 6, nylon 6/ethylene-vinyl alcohol copolymer/nylon 6) and mixtures. Among these, those having mechanical strength and dimensional stability are preferable.

When the second substrate is the outermost layer of the laminate, the second substrate is preferably a sealant substrate among plastic films.

Examples of sealant substrates include polyethylenes such as low density polyethylene (LDPE), linear low density polyethylene (LLDPE), and high density polyethylene (HDPE), acid-modified polyethylene, polypropylene (PP), acid-modified polypropylene, copolymerized polypropylene, ethylene-vinyl acetate copolymers, ethylene-(meth)acrylic acid ester copolymers, ethylene-(meth)acrylic acid copolymers, and ionomers.

In addition, when unevennesses having a height difference of about several μm are provided on the sealant substrate, it is possible to impart slip properties and tearability to the packaging bag.

The thickness of the first substrate can be arbitrarily selected, and in consideration of moldability and transparency, and the thickness is preferably 5 μm to 50 μm, and more preferably 10 μm to 40 μm. If the film thickness of the first substrate is 5 μm or more, this is preferable because the rigidity of the laminate increases, the strength of the laminate is improved, for example, it is possible to prevent the occurrence of delamination and wrinkles that are likely to occur when an impact is applied. If the thickness of the first substrate is 50 μm or less, this is preferable because the flexibility of the laminate increases, and for example, processing when a packaging bag is filled with contents becomes easier.

The film thickness of the second substrate can be arbitrarily selected, and in consideration of the strength of the packaging material and the like, the film thickness is preferably 5 μm to 500 μm, more preferably 10 μm to 250 μm, and still more preferably 15 μm to 200 μm. If the thickness of the second substrate is 5 μm or more, the heat seal strength is improved. This is preferable because heavier contents can be filled and the range of applications as a packaging bag extends. In addition, if the thickness of the second substrate is 500 μm or less, this is preferable because cost is reduced, the flexibility of the laminate increases, and for example, the processability of filling the contents is improved.

In order to improve the adhesion to the ink layer or the adhesive layer, in addition to a corona discharge treatment and an ozone treatment, the substrate may be subjected to a surface treatment such as a low-temperature plasma treatment using oxygen gas, nitrogen gas or the like; a physical treatment such as a glow discharge treatment; a chemical treatment such as an oxidation treatment using chemicals; a treatment of forming an adhesive layer, a primer coating agent layer, an undercoat layer, or a vapor deposited anchor coating agent layer; and other treatments, before lamination or vapor deposition. In addition, an inorganic vapor deposited layer is provided after the surface treatment, and a barrier coat layer may be additionally provided on the inorganic vapor deposited layer.

The resin film used for the first substrate and the second substrate can be produced, for example, using one, two or more resins selected from among the group of resins described above and using a known film forming method. Examples of such film forming methods include an extrusion method, a cast molding method, a T-die method, a cutting method, an inflation method, and a multilayer coextrusion method. In addition, in consideration of the film strength, dimensional stability, and heat resistance, for example, stretching can be performed in a uniaxial or biaxial direction using a tenter method or a tubular method.

In order to improve and modify processability, heat resistance, weather resistance, mechanical properties, dimensional stability, antioxidative properties, slip properties, mold release properties, flame retardance, anti-mold properties, electrical properties, strength and the like, as necessary, plastic compounding agents and additives such as a lubricant, a crosslinking agent, an antioxidant, an ultraviolet absorber, a light stabilizer, a filling agent, a reinforcing agent, an antistatic agent, and a pigment can be added to the plastic film, and it can be added in any amount depending on the purpose as long as it does not adversely affect other performance.

The laminate of the disclosure can be produced by, for example, printing a water-based flexo ink (F) on a first substrate, performing drying, and then applying a solvent-free adhesive (S), superimposing a second substrate, and then curing the adhesive according to an aging process. A plurality of ink layers and second substrates may be provided. For example, the ink layer may have a structure: colored ink layer/white ink layer, colored ink layer/white ink layer/white ink layer, or colored ink layer/colored ink layer/white ink layer/white ink layer. An example of the structure of the laminate of the disclosure is shown below, but the disclosure is not limited thereto. When the laminate has a plurality of adhesive layers, at least one layer of the adhesive layers may be an adhesive layer formed from the solvent-free adhesive (S) in the disclosure. In addition, in the following, transparent vapor deposition means depositing a vapor layer of silica or alumina.
biaxially stretched polypropylene (OPP)/ink layer/adhesive layer/unstretched polypropylene (CPP),
OPP/ink layer/adhesive layer/AL vapor deposited CPP,
OPP/ink layer/adhesive layer/AL vapor deposited polyethylene terephthalate (AL vapor
deposited PET),
OPP/ink layer/adhesive layer/polyethylene(PE),
OPP/ink layer/adhesive layer/AL vapor deposited polyethylene (AL vapor deposited PE),
PET/ink layer/adhesive layer/CPP,
PET/ink layer/adhesive layer/AL vapor deposited CPP,
PET/ink layer/adhesive layer/AL vapor deposited PET,
PET/ink layer/adhesive layer/PE,
PET/ink layer/adhesive layer/AL vapor deposited PE,
PE/ink layer/adhesive layer/CPP,
PE/ink layer/adhesive layer/AL vapor deposited CPP,
PE/ink layer/adhesive layer/AL vapor deposited PET,
PE/ink layer/adhesive layer/PE,
PE/ink layer/adhesive layer/AL vapor deposited PE,
nylon (NY)/ink layer/adhesive layer/CPP,
NY/ink layer/adhesive layer/AL vapor deposited CPP,
NY/ink layer/adhesive layer/AL vapor deposited PET,
NY/ink layer/adhesive layer/PE,
NY/ink layer/adhesive layer/AL vapor deposited PE
PET/ink layer/adhesive layer/NY/adhesive layer/CPP,
PET/ink layer/adhesive layer/NY/adhesive layer/PE,
transparent vapor deposited PET/ink layer/adhesive layer/NY/adhesive layer/CPP,
transparent vapor deposited PET/ink layer/adhesive layer/NY/adhesive layer/PE,
PET/ink layer/adhesive layer/AL vapor deposited PET/adhesive layer/CPP,
PET/ink layer/adhesive layer/AL vapor deposited PET/adhesive layer/PE,
NY/ink layer/adhesive layer/AL vapor deposited PET/adhesive layer/CPP,
NY/ink layer/adhesive layer/AL vapor deposited PET/adhesive layer/PE,
PET/ink layer/adhesive layer/AL vapor deposited PET/adhesive layer/NY/adhesive layer/CPP,
PET/ink layer/adhesive layer/AL vapor deposited PET/adhesive layer/NY/adhesive layer/PE,
PET/ink layer/adhesive layer/AL/adhesive layer/CPP,
PET/ink layer/adhesive layer/AL/adhesive layer/PE,
PET/ink layer/adhesive layer/NY/adhesive layer/AL/adhesive layer/CPP,
PET/ink layer/adhesive layer/NY/adhesive layer/AL/adhesive layer/PE,
PET/ink layer/adhesive layer/AL/adhesive layer/NY/adhesive layer/CPP,
PET/ink layer/adhesive layer/AL/adhesive layer/NY/adhesive layer/PE

<<Package>>

A package of the disclosure may be one using the laminate, and examples thereof include a two-sided bag, a three-sided bag, a three-sided bag with a zipper, a butt bag, a gusset bag, a bottom gusset bag, a stand bag, a stand zipper bag, a two-sided bag, a four-sided columnar flat bottom gusset bag, a side sealed bag, and a bottom sealed bag. Since the package of the disclosure can minimize a decrease in flexibility of the adhesive layer and a decrease in substrate conformability caused by the reaction between the residual hydroxyl group-containing component derived from a water-based flexo ink (F) and the isocyanate component derived from a solvent-free adhesive (S), it is particularly suitably used during the summer and in high humidity environment areas in which the residual hydroxyl group-containing component tends to remain in the water-based flexo ink (F). In addition, it particularly exhibits effects when the packaging bag is subjected to long-term distortion during a processing process, a filling process, a distribution process and the like.

### EXAMPLES

Hereinafter, the disclosure will be described in detail with reference to examples and comparative examples. Unless otherwise specified, “parts” and “%” in examples and comparative examples refer to “parts by mass” and “mass %.”

<Storage Elastic Modulus and Loss Tangent of Adhesive Layer>

The storage elastic modulus of the adhesive layer was measured as follows based on JIS K 7244. First, the prepared solvent-free adhesive was mixed and made homogenous using a rotation and revolution type vacuum defoaming machine (“ARV-310P” commercially available from Thinky Corporation) and was then thinly spread on a non-corona-treated CPP film using an applicator so that the thickness was 10 to 100 μm, is sandwiched by the same film being used above, and left in an environment of 40° C. and 65% RH for 10 days, and the adhesive was cured to produce a laminate. Subsequently, the laminate was cut into a length of 20 mm and a width of 5 mm, and the CPP film was peeled off to obtain a test piece (cured film) with a length of 20 mm, a width of 5 mm, and a thickness of 100 μm. For the obtained test piece, using a dynamic viscoelasticity measuring device (“DVA-200” commercially available from IT Measurement Control Co., Ltd.), the storage elastic modulus and the loss tangent of the test piece were measured under conditions of a measurement temperature of 20° C., a frequency of 10 Hz, and a heating rate of 10° C./min, and the values of the storage elastic modulus and the loss tangent at 20° C. were calculated.

<Storage Elastic Modulus and Loss Tangent of Ink Layer>

The storage elastic modulus of the ink layer was measured as follows. First, the prepared water-based flexo ink was poured into a silicone container so that the thickness after drying was 10 to 1,000 μm, and the solvent was evaporated by heating at 40° C. Subsequently, the ink layer after drying was cut into a width 5 mm×a length of 20 mm to produce a test piece. For the obtained test piece, using a dynamic viscoelasticity measuring device (“DVA-200” commercially available from IT Measurement Control Co., Ltd.), the storage elastic modulus and the loss tangent of the test piece were measured under conditions of a measurement temperature of 20° C., a frequency of 10 Hz, and a heating rate of 10° C./min, and the values of the storage elastic modulus and the loss tangent at 20° C. were calculated.

<Number-Average Molecular Weight>

The number-average molecular weight was measured using gel permeation chromatography (GPC) (“ShodexGPCSystem-21” commercially available from Showa Denko K.K.). GPC is liquid chromatography in which substances dissolved in a solvent are separated and quantified based on the difference in the molecule size, and tetrohydrofuran was used as the solvent, and the molecular weight was determined in terms of polystyrene.

<Production of Polyol (A)>

### (Polyol A-1)

332.7 parts of adipic acid, 126.1 parts of isophthalic acid, 126.1 parts of terephthalic acid, 83.4 parts of ethylene glycol, 285.1 parts of diethylene glycol, and 46.6 parts of neopentyl glycol were put into a reaction container including a stirrer, a thermometer, a reflux cooling pipe, a drop tank and a nitrogen gas introduction pipe, and the temperature was raised to 240° C. with stirring under a nitrogen gas flow. After the reaction was continued until the acid value reached 5 mg KOH/g or less, the pressure was gradually reduced, the reaction was continued at 1 mmHg to remove an excess alcohol, and a polyester polyol 1 having a number-average molecular weight of 2,500 was obtained.

Next, 400.0 parts of the polyester polyol 1 obtained above and 400.0 parts of castor oil were put into a reaction container including a stirrer, a thermometer, a reflux cooling pipe, a drop tank and a nitrogen gas introduction pipe and stirred at 80° C. for 1 hour to obtain a polyol (A-1).

<Production of Polyisocyanate (B)>

### (Polyisocyanate (B-1))

574.0 parts of the polyester polyol 1 having a number-average molecular weight of 2,500 obtained in the same manner as above and 226.0 parts of a mixture of 4,4′-diphenylmethane diisocyanate and 2,4-diphenylmethane diisocyanate (a mass ratio of 50:50) were put into a reaction container including a stirrer, a thermometer, a reflux cooling pipe, a drop tank and a nitrogen gas introduction pipe and heated at 80° C. to 90° C. for 3 hours with stirring under a nitrogen gas flow to cause a urethanization reaction, and thereby a polyisocyanate (B-1) as a polyester polyurethane polyisocyanate having an NCO content of 7.1% was obtained.

Here, the ratio (NCO/OH) of the number of hydroxyl groups in the polyol and the number of isocyanate groups in the polyisocyanate during urethaneization was 4.

### (Polyisocyanate (B-2))

291.6 parts of adipic acid, 165.8 parts of isophthalic acid, 165.8 parts of terephthalic acid, 139.9 parts of ethylene glycol, 119.6 parts of diethylene glycol, and 117.353 parts of neopentyl glycol were put into a reaction container including a stirrer, a thermometer, a reflux cooling pipe, a drop tank and a nitrogen gas introduction pipe, and the temperature was raised to 240° C. with stirring under a nitrogen gas flow. After the reaction was continued until the acid value reached 5 mg KOH/g or less, the pressure was gradually reduced, the reaction was continued at 1 mmHg to remove an excess alcohol, and a polyester polyol 2 having a number-average molecular weight of 3,300 was obtained.

Next, 618.5 parts of the polyester polyol 2 having a number-average molecular weight of 3,300 obtained above and 181.5 parts of a mixture of 4,4′-diphenylmethane diisocyanate and 2,4-diphenylmethane diisocyanate (a mass ratio of 50:50) were put into a reaction container including a stirrer, a thermometer, a reflux cooling pipe, a drop tank and a nitrogen gas introduction pipe and heated at 80° C. to 90° C. for 3 hours with stirring under a nitrogen gas flow to cause a urethanization reaction, and thereby a polyisocyanate (B-2) as a polyester polyurethane polyisocyanate having an NCO content of 5.7% was obtained.

Here, the ratio (NCO/OH) of the number of hydroxyl groups in the polyol and the number of isocyanate groups in the polyisocyanate during urethaneization was 4.

(Polyisocyanate (B-3))

503.0 parts of the polyester polyol 1 having a number-average molecular weight of 2,500 obtained in the same manner as above and 297.0 parts of a mixture of 4,4′-diphenylmethane diisocyanate and 2,4-diphenylmethane diisocyanate (a mass ratio of 50:50) were put into a reaction container including a stirrer, a thermometer, a reflux cooling pipe, a drop tank and a nitrogen gas introduction pipe, and heated at 80° C. to 90° C. for 3 hours with stirring under a nitrogen gas flow to cause a urethanization reaction, and thereby a polyisocyanate (B-3) as a polyester polyurethane polyisocyanate having an NCO content of 10.4% was obtained.

Here, the ratio (NCO/OH) of the number of hydroxyl groups in the polyol and the number of isocyanate groups in the polyisocyanate during urethaneization was 6.

<Production of Printed Material>

### (Production of Printed Material 1: PET/Ink Layer)

The water-based flexo ink was printed on a corona-treated polyester (PET) substrate (“E5102” commercially available from Toyobo Co., Ltd., a thickness of 12 μm) at a rate of 200 m/min using a flexo printing machine (MIRAFLEX CM) including a flexoplate (FLEXCEL NXH photosensitive resin plate commercially available from KODAK, a digital flexo plate thickness of 1.14 mm and a number of printing lines of 150 lpi) and an anilox roll (900 lpi3cc/m²), and thereby a printed material 1 having an ink layer having a thickness of 1.4 to 1.6 μm was obtained. Here, drying conditions for the ink layer were an intercolor dryer at 100° C., and a tunnel dryer at 100° C.

(Production of Printed Material 2: OPP/Ink Layer)

In the same manner as in the printed material 1, the water-based flexo ink was printed on a corona-treated biaxially stretched polypropylene (OPP) substrate (“P2161” commercially available from Toyobo Co., Ltd., a thickness of 20 μm) at a rate of 200 m/min, and thereby a printed material 2 having an ink layer having a thickness of 0.9 to 1.1 μm was obtained.

<Production of Laminate>

### Examples 1 to 7 and Comparative Examples 1 to 3

The obtained polyol (A) and polyisocyanate (B) were mixed at a blending ratio (mass) shown in Table 1 to obtain each solvent-free adhesive. Using the obtained solvent-free adhesive, laminates of Structure 1 and Structure 2 were produced as follows.

(Laminate of Structure 1: PET/Ink Layer/Adhesive Layer/VM-PET)

The water-based flexo ink shown in Table 1 was printed on a corona-treated polyester (PET) substrate (“E5102” commercially available from Toyobo Co., Ltd., a thickness of 12 μm) at a rate of 200 m/min using a flexo printing machine (MIRAFLEX CM) including a flexoplate (FLEXCEL NXH photosensitive resin plate commercially available from KODAK, a digital flexo plate thickness of 1.14 mm and a number of printing lines of 150 lpi) and an anilox roll (900 lpi3cc/m²), and thereby a printed material 1 having an ink layer having a thickness of 1.4 to 1.6 μm was obtained. Here, drying conditions for the ink layer were an intercolor dryer at 100° C., and a tunnel dryer at 100° C.

Next, using a laminator under a room temperature environment, the ink surface of the printed material 1 and the aluminum vapor deposited surface of an aluminum vapor deposited polyester (PET) substrate having a thickness of 12 μm (“DIALUSTER H27” commercially available from REIKO Co., Ltd., hereinafter referred to as VM-PET) were bonded together using the solvent-free adhesive shown in Table 1 to obtain a laminate having a length of 1,000 m. The lamination rate was 200 m/min, and the thickness of the adhesive layer was 1.9 to 2.1 μm.

The bonded laminate was stored in a 40° C. environment and taken out after 48 hours to obtain a laminate having a structure of “PET/ink layer/adhesive layer/VM-PET” (Structure 1).

(Production of Laminate of Structure 2: OPP/Ink Layer/Adhesive Layer/VM-CPP)

In the same manner as in the printed material 1, the water-based flexo ink shown in Table 1 was printed on a corona-treated biaxially stretched polypropylene (OPP) substrate (“P2161” commercially available from Toyobo Co., Ltd., a thickness of 20 μm) at a rate of 200 m/min, and thereby a printed material 2 having an ink layer having a thickness of 0.9 to 1.1 μm was obtained.

Next, using a laminator under a room temperature environment, the ink surface of the printed material 2 and the aluminum vapor deposited surface of an aluminum vapor deposited unstretched polypropylene film having a thickness of 25 μm (“2703” commercially available from Toray Industries, Inc., hereinafter referred to as VM-CPP) were bonded together using the solvent-free adhesive shown in Table 1 to obtain a laminate having a length of 1,000 m. The lamination rate was 250 m/min, and the thickness of the adhesive layer was 1.7 to 1.9 μm.

The bonded laminate was stored in a 40° C. environment and taken out after 48 hours to obtain a laminate having a structure of “OPP/ink layer/adhesive layer/VM-CPP” (Structure 2).

<Evaluation of Laminate>

The following evaluations were performed using the two types of laminates obtained. The results are shown in Table 1.

<Substrate Conformability (Resistance to Bending and Delamination Over Time)>

The laminate of Structure 1 was cut into a width of 10 cm and a length of 15 cm to produce a test piece. The test piece was folded in three, and the folded parts were held and fixed with a gem clip. An operation in which the bending test piece was stored in an environment of a temperature of 40° C. and a relative humidity of 70%, the test piece was taken out every day, and the part held with the gem clip was spread out and observed, and then held again with the gem clip, and returned to the same environment was repeated. Changes observed during the procedure were evaluated based on the following criteria.
A: no delamination was confirmed even after 7 days (very good)
B: delamination was confirmed after 5 days (good)
C: delamination was confirmed after 3 days (usable)
D: delamination was confirmed after 1 day (unusable)

<Adhesive Strength>

The laminate of Structure 2 was cut into a width of 15 mm and a length of 300 mm to produce a test piece. Based on JIS K 6854, using an instron type tensile testing machine, in an environment of a temperature of 20° C. and a relative humidity of 65%, pulling was performed at a peeling rate of 300 mm/min, and the T-type peel strength [N/15 mm] between OPP and VM-CPP was measured. The measurement was performed five times and the average value was used for evaluation based on the following criteria.
A: 1.5 [N/15 mm] or more (very good)
B: 1.0 [N/15 mm] or more and less than 1.5 [N/15 mm] (good)
C: 0.5 [N/15 mm] or more and less than 1.0 [N/15 mm] (usable)
D: less than 0.5 [N/15 mm] (unusable)

<Peeling Between VM/CPP>

After the adhesive strength was evaluated using the laminate of Structure 2, regarding the peeled test piece, the peeling state between the VM (vapor deposited aluminum) layer/CPP was visually observed, and the area % in which the VM layer was peeled off of the CPP was determined. A case in which the VM layer was not peeled off of the CPP was set as 0 area %, and a case in which the entire VM layer was peeled off of the CPP was set as 100 area %.

When the adhesive layer was more rigid (the storage elastic modulus was higher), peeling occurred between the VM layer/CPP rather than between the adhesive layer/VM layer.

TABLE 1

| | | Example | | | | | | | Comparative Example | | |
|---|---|---|---|---|---|---|---|---|---|---|---|
| | | 1 | 2 | 3 | 4 | 5 | 6 | 7 | 1 | 2 | 3 |
| Water-based | Product name | TW100 | TW100 | HW870 | TW100 | TW100 | TW100 | TW100 | TW100 | TW100 | TW100 |
| flexo ink (F) | | indigo | white | indigo | indigo | indigo | indigo | indigo | indigo | indigo | indigo |
| | 20° C. Er [MPa] | 600 | 800 | 700 | 600 | 600 | 600 | 600 | 600 | 600 | 600 |
| | 20° C. tanδ [—] | 0.4 | 0.3 | 0.6 | 0.4 | 0.4 | 0.4 | 0.4 | 0.4 | 0.4 | 0.4 |
| Solvent-free | Polyol (A) | TSN- | TSN- | TSN- | A-1 | TSN- | EA- | TSN- | TSN- | TSN- | TSN- |
| adhesive (S) | | 5092A | 5092A | 5092A | | 5092A | N373B | 5092A | 4864A | 5092A | 5092A |
| | Polyisocyanate | TSN- | TSN- | TSN- | TSN- | B-1 | TSN- | TSN- | TSN- | B-2 | B-3 |
| | (B) | 5092C | 5092C | 5092C | 5092C | | 5092C | 5092B | 5092C | | |
| | Blending ratio | 100/100 | 100/100 | 100/100 | 100/80 | 100/200 | 100/150 | 100/70 | 100/100 | 100/250 | 100/150 |
| | 20° C. Er [MPa] | 20 | 20 | 20 | 400 | 450 | 15 | 10 | 2000 | 800 | 1200 |
| | 20° C. tanδ [—] | 0.35 | 0.35 | 0.35 | 0.75 | 0.60 | 0.90 | 0.95 | 0.10 | 0.10 | 0.05 |
| Evaluation | Substrate | A | A | A | A | A | A | A | D | D | D |
| | conformability | | | | | | | | | | |
| | PET/VMPET | | | | | | | | | | |
| | Adhesive | A | A | B | B | B | C | C | D | D | D |
| | strength | | | | | | | | | | |
| | OPP/VMCPP | | | | | | | | | | |
| | Peeling | 0 | 0 | 0 | 0 | 0 | 0 | 0 | 100 | 100 | 100 |
| | between | | | | | | | | | | |
| | VM/CPP | | | | | | | | | | |
| | area % | | | | | | | | | | |

The abbreviations in Table 1 are shown below.

### <Water-Based Flexo Ink>

TW100 indigo: water-based flexo indigo ink “TW100AQ39 indigo” (commercially available from Toyo Ink Co., Ltd.), TW100 white: water-based flexo white ink “TW100AQ63 white” (commercially available from Toyo Ink Co., Ltd.), HW870 indigo: water-based flexo indigo ink “HW870 AQUA LIONA R39 indigo” (commercially available from Toyo Ink Co., Ltd.)

<Polyol>
TSN-5092A: solvent-free adhesive “ECOAD TSN-5092A” (including aliphatic polyester polyol and polyether polyol) (commercially available from Toyo-Morton, Ltd.)
EA-N373B: solvent-free adhesive “ECOAD EA-N373B” (polyether polyurethane polyol) (commercially available from Toyo-Morton, Ltd.)
TSN-4864A: solvent-free adhesive “ECOAD TSN-4864A” (polyester polyol) (commercially available from Toyo-Morton, Ltd.)
A-1: a mixture of polyester polyol and castor oil polyol

<Polyisocyanate>
TSN-5092C: solvent-free adhesive “ECOAD TSN-5092C” (commercially available from Toyo-Morton, Ltd.) (a polyester polyurethane polyisocyanate which is a reaction product ((NCO/OH)=4) of an aliphatic polyester polyol having a number-average molecular weight of 2,000 and a polyisocyanate, an NCO content of 15.7%)
TSN-5092B: solvent-free adhesive “ECOAD TSN-5092B” (commercially available from Toyo-Morton, Ltd.) (a polyether polyurethane polyisocyanate which is a reaction product ((NCO/OH)=4) of a polyether polyol and a polyisocyanate, an NCO content of 21.5%)
B-1: a polyester polyurethane polyisocyanate which is a reaction product ((NCO/OH)=4) of a polyester polyol having a number-average molecular weight of 2,500 and a polyisocyanate (a mixture of 4,4′-diphenylmethane diisocyanate and 2,4-diphenylmethane diisocyanate (a mass ratio of 50:50)), an NCO content of 7.1%
B-2: a polyester polyurethane polyisocyanate which is a reaction product ((NCO/OH)=4) of a polyester polyol having a number-average molecular weight of 3,300 and a polyisocyanate (a mixture of 4,4′-diphenylmethane diisocyanate and 2,4-diphenylmethane diisocyanate (a mass ratio of 50:50)), an NCO content of 5.7%
B-3: a polyester polyurethane polyisocyanate which is a reaction product ((NCO/OH)=6) of a polyester polyol having a number-average molecular weight of 2,500 and a polyisocyanate (a mixture of 4,4′-diphenylmethane diisocyanate and 2,4-diphenylmethane diisocyanate (a mass ratio of 50:50)), an NCO content of 10.4%

According to the evaluation results, the laminate of the disclosure in which the storage elastic modulus of the adhesive layer had a predetermined value had excellent substrate conformability and adhesive strength.

Particularly, Example 1 using the polyol (A) containing polyester polyol and polyether polyol had a smaller value of tan δ, that is, higher elasticity and better adhesive strength, than Example 6 using the polyol (A) containing only polyether polyurethane polyol.

In addition, Example 1 using the polyisocyanate (B) containing a polyester polyurethane polyisocyanate which is a reaction product ((NCO/OH)=4) of a polyester polyol having a number-average molecular weight of 2,000 and a polyisocyanate had a smaller value of tan δ, that is, higher elasticity of the adhesive layer, and better adhesive strength, than Example 7 using the polyisocyanate (B) containing polyether polyurethane polyisocyanate.

In addition, Example 1 using the polyol (A) containing an aliphatic polyester polyol had a smaller value of tan δ at 20° C., that is, higher elasticity of the adhesive layer, and better adhesive strength, than Example 4 using the polyol (A-1) containing a polyol that did not correspond to the aliphatic polyester polyol.

Example 1 using the polyisocyanate (B) derived from an aliphatic polyester polyol had a smaller value of tan δ at 20° C., that is, higher elasticity of the adhesive layer, and better adhesive strength, than Example 5 using the polyisocyanate (B-1) derived from a polyol that did not correspond to the aliphatic polyester polyol.

Example 1 using the water-based flexo ink with a tan δ value at 20° C. in a range of 0.2 to 0.5 had higher elasticity of the ink layer and better adhesive strength than Example 3 using the water-based flexo ink with a tan δ value at 20° C. in a range of more than 0.5.

Priority is claimed on Japanese Patent Application No. 2022-177760, filed Nov. 7, 2022, the content of which is incorporated herein by reference.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A laminate having a first substrate layer, an ink layer, an adhesive layer, and a second substrate layer in order and satisfying (1) to (2) as follows:
(1) the ink layer is a layer formed by using a water-based flexo ink (F);
(2) the adhesive layer is a layer formed by using a solvent-free adhesive (S) containing a polyol (A) and a polyisocyanate (B), and has a storage elastic modulus (Er) of 600 MPa or less at 20° C. measured based on JIS K 7244.

2. The laminate according to claim 1,
wherein the polyol (A) contains a polyester polyol (a1) and at least one polyol (a2) selected from a group consisting of a castor oil-based polyol and a polyether polyol.

3. The laminate according to claim 2,
wherein the polyester polyol (a1) contains a reaction product of polybasic acids containing 90 mass % or more of aliphatic polybasic acids and polyhydric alcohols containing 90 mass % or more of aliphatic polyhydric alcohols.

4. The laminate according to claim 1,
wherein the polyisocyanate (B) contains a polyurethane polyisocyanate which is a reaction product of a polyester polyol (b1) having a number-average molecular weight of 1,000 to 3,000 and a polyisocyanate (b2).

5. The laminate according to claim 4,
wherein the polyester polyol (b1) contains a reaction product of polybasic acids containing 90 mass % or more of aliphatic polybasic acids and polyhydric alcohols containing 90 mass % or more of aliphatic polyhydric alcohols.

6. The laminate according to claim 2,
wherein the polyisocyanate (B) contains a polyurethane polyisocyanate which is a reaction product of a polyester polyol (b1) having a number-average molecular weight of 1,000 to 3,000 and a polyisocyanate (b2).

7. The laminate according to claim 6,
wherein the polyester polyol (b1) contains a reaction product of polybasic acids containing 90 mass % or more of aliphatic polybasic acids and polyhydric alcohols containing 90 mass % or more of aliphatic polyhydric alcohols.

8. The laminate according to claim 3,
wherein the polyisocyanate (B) contains a polyurethane polyisocyanate which is a reaction product of a polyester polyol (b1) having a number-average molecular weight of 1,000 to 3,000 and a polyisocyanate (b2).

9. The laminate according to claim 8,
wherein the polyester polyol (b1) contains a reaction product of polybasic acids containing 90 mass % or more of aliphatic polybasic acids and polyhydric alcohols containing 90 mass % or more of aliphatic polyhydric alcohols.

10. The laminate according to claim 1,
wherein the water-based flexo ink (F) contains water-based urethane resin.

11. The laminate according to claim 10,
wherein the water-based urethane resin has a carboxy group in the resin, and the carboxy group is neutralized by using at least one basic compound selected from a group consisting of ammonia and an organic base compound.

12. The laminate according to claim 1,
wherein the ink layer has a storage elastic modulus (Er) of 1,000 MPa or less at 20° C. measured based on JIS K 7244.

13. The laminate according to claim 1,
wherein the adhesive layer has a loss tangent (tan δ) of 0.2 to 0.8 at 20° C. measured based on JIS K 7244.

14. The laminate according to claim 1,
wherein the ink layer has a loss tangent (tan δ) of 0.2 to 0.8 at 20° C. measured based on JIS K 7244.

15. A package using the laminate according to claim 1.
